(19) United States
(12) Patent Application Publication
(10) Pub. No.: US 2007/0180128 A1
(43) Pub. Date: Aug. 2, 2007

(54) User account validity definition in clustered computer systems

(75) Inventors: George G. Behrend, New York, NY (US); Christopher V. DeRobertis, Hopewell Junction, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: International Business Machines Corporation, Armonk, NY (US)

(21) Appl. No.: 11/334,210

(22) Filed: Jan. 18, 2006

(51) Int. Cl. H04L 9/32; G06F 15/16

(52) U.S. Cl. 709/229; 726/4

(57) ABSTRACT

Disclosed are a method of and system for defining user account validity in a cluster of computer systems. The method comprises the steps of providing a centralized management system for said cluster; and using said centralized management system to maintain a record indicating, for each user of the cluster, whether the user is valid on each of the computer systems in the cluster. Preferably, the step of using said centralized management system includes the step of using said centralized management system to create a user account validity definition, and to identify in said definition which ones of the users are valid on which ones of the computer systems.

### BACKGROUND OF THE INVENTION

1. Field of the invention

This invention generally relates to computer clusters, and more specifically, to user account validity definitions in computer clusters.

2. Background Art

A computer cluster is a collection of one or more computer systems that are linked together to cooperatively perform computer-implemented tasks, such as providing client computers with access to a set of services and resources. Typically, computer clusters are fault tolerant and are provided with load balancing algorithms.

Each computer of a computer cluster may be a multiprocessor system itself. For example, a cluster of four computers, each with four CPUs, would provide a total of 16 CPUs processing simultaneously. If one of the computers fails, one or more additional computers are still available and may actually take over the functions of the failed computer. In addition, load-balancing mechanisms in the computer cluster are able to distribute the workload over the multiple computer systems, thereby reducing the burden on each of the computer systems.

Another important advantage of a computer cluster is its scalability, as it has the flexibility to enable additional cluster elements to be added to the cluster or incorporated within existing cluster elements. Further, a computer cluster provides the flexibility to enable existing cluster elements, or components within a cluster element, to be upgraded or modified.

User management systems for a cluster of computer systems (such as UNIX authentication via LDAP or NIS) provide a centralized facility to create, delete and modify user accounts that are valid for all systems that are part of the cluster. A user account that is valid on a system provides the ability for login access, and file and process creation, deletion, and ownership. In some instances, while central user management is essential, it may not be desirable that a user account be valid on all systems in a cluster. A mechanism presently exists to restrict the systems where a user may login. For example, some operating systems include attributes hostsallowedlogin and hostsdeniedlogin, which define a set of computer systems where a user account may or may not gain login access. Also, the login facility ssh is configurable to define which user accounts are valid for login access. Both methods, however, do not prevent the user account from being used to create, delete, and own files or processes. To prevent a user from performing such activities, the user simply must not be defined on the system. Presently, in centralized user management systems, such “selective validity” is not available or configurable: Either the user is valid on all nodes in the cluster or it is not, irrespective of whether or not a user may login to one or more nodes.

### SUMMARY OF THE INVENTION

An object of this invention is to improve computer clusters.

Another object of the present invention is to provide a new user account validity definition in clustered computer systems.

A further object of the invention is to provide an administrator of a computer cluster with selective validity on the nodes of the cluster.

An object of the invention is to create a user account in a computer cluster and to use that user account name to determine where the user exists or does not exist in the cluster.

These and other objectives of the invention are achieved with a method of and system for defining user account validity in a cluster of computer systems. The method comprises the steps of providing a centralized management system for said cluster; and using said centralized management system to maintain a record indicating, for each user of the cluster, whether the user is valid on each of the computer systems in the cluster. Preferably, the step of using said centralized management system includes the step of using said centralized management system to create a user account validity definition, and to identify in said definition which ones of the users are valid on which ones of the computer systems.

Also, preferably, each of the computer systems of the cluster is provided with a user authentication module; and when one of the users requests authentication on one of the computer systems, the user authentication module of that one of the computer systems is used to determine whether that one of the users is valid on that one of the computer systems. For example, the centralized management system may be used to maintain a list on the centralized management system identifying which of the users have access to which of the computer systems; and when one of the users requests authentication on one of the computer systems, the user authentication module the one of the computer systems is used to ask the centralized management system whether the one of the users is valid on the one of the computer systems. Alternatively, each of the computer systems may be provided with a cache of user account values; and when one of the users requests authentication on one of the computer systems, the user authentication module of that one of the computer systems is used to access the cache of user account values of that one of the computer systems to determine if the requesting user is valid on the one of the computer systems.

With the preferred embodiment of the invention, described in detail below, user authentication modules on an individual system in the cluster check an attribute that defines a user account's “validity” on the local system for each request processed by the module. If the attribute defines the user as “valid” on the system, then the request proceeds normally. If the attribute defines the user as “not valid”, then the module would return an error status that “the user does not exist” on the local system to the requestor.

With this mechanism in place, a cluster administrator managing a cluster of 1000 nodes, for example, has the ability to centrally define user accounts, but can isolate the validity of a single account to 400 of those nodes where the user is permitted to manage processes and files. The account would not be valid on the other 600 nodes in the cluster where the user is not permitted to manage processes and files. This is more convenient and efficient than having to define the user manually on 400 nodes.

An important advantage of this technique is that an administrator can create a user account in a cluster and decide where the user exists or does not exist in the cluster. With the mechanism of this invention in place—and in contrast to the use of the above-mentioned hostdeniedlogin attribute—the computer operating system will not allow the creation of files, processes, or other system resources (su for example) for or associated with a user id. For all intents and purposes, the user id does not exist on that host. As an added benefit, if the user's access requirements grow to an additional 200 nodes, for example, then the validity definition only needs to be changed, instead of creating the user account on the additional 200 nodes. The mechanism can also be used to temporarily suspend the validity of a user account in a cluster while preserving the user's definition in the central user management system.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 illustrates a computer cluster.

FIG. 2 is an exemplary diagram showing a distributed data processing system that may be used in the present invention.

FIG. 3 shows attributes that specify where a user account is valid and not valid in a computer cluster.

FIG. 4 illustrates an example of node groups that may be used in the present invention.

### DETAILED DESCRIPTION OF THE PREFERRED EMBODIMENTS

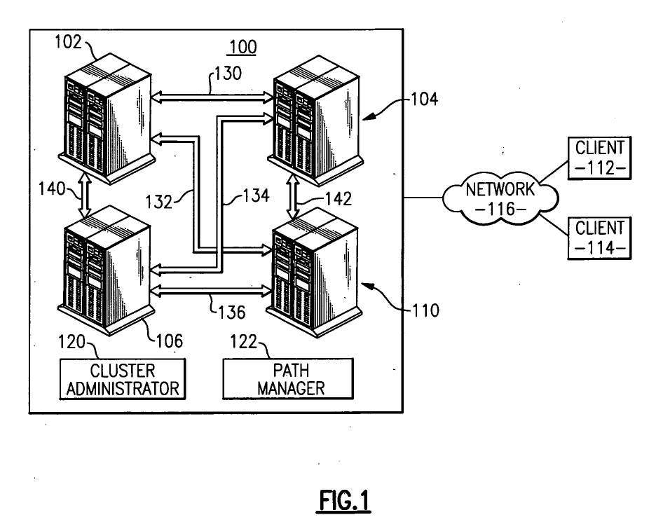

FIG. 1 illustrates a computer cluster 100 comprising a plurality of computer systems or nodes 102, 104, 106, 110, and this cluster is connected to clients 112 and 114 via network 116. FIG. 1 also shows a cluster administrator 120 and a path manager 122.

The computing systems 102, 104, 106, 110 constitute a cluster in which a first computing system may be used as a backup of a second computing system should the second computing system fail. The functions and resources of the failed second computing system may be taken over by the first computing system in a manner generally known in the art.

The computing systems 102, 104, 106, 110 may be any type of computing system that may be arranged in a cluster with other computing systems. For example, the computing systems 102, 104, 106, 110 may be server computers, client computers, and the like. The computing systems 102, 104, 106, 110 may be single processor systems or multiprocessor systems. In short, any type of computing system that may be used in a cluster with other computing systems is intended to be within the spirit and scope of the present invention.

The computing systems 102, 104, 106, 110 are coupled to one another via communication links 130, 132, 134, 136, 140, 142. The communication links 130, 132, 134, 136, 140, 142 may be any type of communication links that provide for the transmission of data between the computing systems 102, 104, 106, 110. For example, the communication links may be wired, wireless, fiber optic links, satellite links, infrared links, data buses, a local area network (LAN), wide area network (WAN), the Internet, or the like. Any type of communication link may be used without departing from the spirit and scope of the present invention.

Cluster administrator 120 is provided to manage computer cluster 100 and, for instance, provides a centralized facility to create, delete and modify user accounts. Path manager 122 is provided to route data between the computer systems of cluster 100. In a preferred embodiment, path manager 122 operates in a distributed fashion through a local component residing within each node in cluster 100. Path manager 122 knows about the interconnection topology of cluster 100 and monitors the status of communication pathways through the cluster. Path manager 122 also provides an interface registry through which other components interested in the status of the interconnect can register. This provides a mechanism for the path manager to make callbacks to the interested components when the status of a path changes, if a new path comes up, or if a path is removed.

Clients 112 and 114 can include any node on network 116 having a computational capability and including a mechanism for communicating across network 116. In one embodiment of the present invention, clients 112 and 114 communicate with cluster 100 by sending packets to the cluster in order to request services from the cluster.

Network 116 can include any type of wire or wireless communication channel capable of coupling together computing nodes. This includes, but is not limited to, a local area network, a wide area network, or a combination of networks. For example, network may be or include the Internet.

Referring to FIG. 2, a block diagram of a data processing system that may be implemented as a computing system in a clustered system, such as clustered system 100 in FIG. 1, is depicted. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 102, 104, 106, 110 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

As mentioned above, presently, in centralized user management computer clusters, selective validity of users on individual computer systems is not available or configurable: Either the user is valid on all nodes or it is not, irrespective of whether or not a user may login to one or more nodes. The present invention provides such selective validity. Generally, in accordance with this invention, user authentication modules on an individual system in the cluster check an attribute that defines a user account's “validity” on the local system for each request processed by the module. If the attribute defines the user as “valid” on the system, then the request proceeds normally. If the attribute defines the user as “not valid,” then the module would return an error status that “the user does not exist” on the local system to the requester.

With this mechanism in place, a cluster administrator managing a cluster of 1000 nodes, for example, has the ability to centrally define user accounts, but can isolate the validity of a single account to 400 of those nodes where the user is permitted to manage processes and files. The account would not be valid on the other 600 nodes in the cluster where the user is not permitted to manage processes and files. This is more convenient and efficient than having to define the user manually on 400 nodes.

An important advantage of this technique is that an administrator can create a user account in a cluster and decide where the user exists or does not exist in the cluster. As an added benefit, if the user's access requirements grow to an additional 200 nodes, for example, then the validity definition only needs to be changed, instead of creating the user account on the additional 200 nodes. The mechanism can also be used to temporarily suspend the validity of a user account in a cluster while preserving the user's definition in the central user management system.

More specifically, in a preferred embodiment, the invention works by including two attributes, validforhosts and invalidforhosts, for example, that define the hosts in the cluster where the user account is valid and invalid. The attribute is preferably included as part of the user account definition in the central user management system (e.g., LDAP or NIS). The authentication module on an individual system in the cluster would, upon request for authentication or authorization for a specific user, check for the validity of that user in the system by requesting the information from the central user management system. The request would be processed at the central server, or locally against a cache of user account values (if configured). Alternatively, a file, /etc/security/validusers, for example, would include attribute definitions for validforhosts and invalidforhosts. This file would then be distributed to each node using a central distribution system such as IBM Cluster Systems Management (CSM) Configuration File Management (CFM). In this configuration, the authentication module on the individual system would instead verify the validity of a user account by reading the local file for each user authentication or authorization request. If a match is not found in the validusers file or its cache, then the system would request the information from the central user management system.

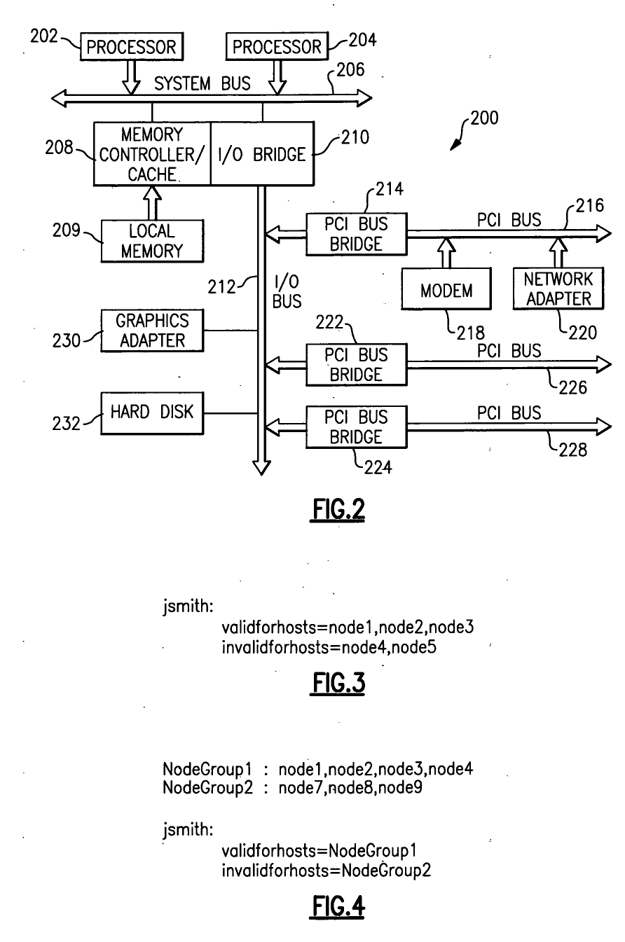

The attributes validforhosts and invalidforhosts specify a list of the hosts where a user account is valid and not valid. For example, consider the user account jsmith shown in FIG. 3. In this case, if any authentication or authorization requests were made for jsmith on node1, node2, or node3, the user account would be considered valid by the user authentication module on those nodes. If any user authentication or authorization requests were made for jsmith on node4 and node5, the user account would be considered as invalid or “non-existent” on those nodes. This means that jsmith cannot login or as another user create processes or files that are owned by jsmith. Although defined in the user management system, the Operating system would treat jsmith as if the account did not exist.

The two valid attributes work together to determine where a user is valid. Both attributes are provided for flexibility when specifying a user's validity. Empty attributes indicate that a user is valid everywhere in the cluster. Wildcards can be used to specify validity: invalidhosts=* means that a user is invalid everywhere in the cluster. If a host H1 is included in both the validforhosts and invalidforhosts, the invalid definition has precedence over the valid definition, and the user account is invalid on host H1.

With the user of the invalidforhosts as described above—and in contrast to the use of the hostdeniedlogin attribute mentioned above—the computer operating system will not allow the creation of files, processes, or other system resources (su for example) for or associated with a user id. For all intents and purposes, the user id does not exist on that host.

To improve the specification of valid hosts, integration of the user management system with a cluster systems management environment, such as IBM CSM can be an option. CSM provides the notion of user definable node groups. A node group, for example as shown in FIG. 4, is a container/reference to addressable nodes within the cluster. Instead of specifying multiple hosts in the validforhosts or invalidforhosts list, a single node group can be used, for instance as shown in FIG. 4.

It should be understood that the present invention can be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different -material form.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

What is claimed is:

1. A method of defining user account validity in a cluster of computer systems, the method comprising the steps of:
providing a centralized management system for said cluster; and
using said centralized management system to maintain a record indicating, for each user of the cluster, whether the user is valid on each of the computer systems in the cluster.

2. A method according to claim 1, wherein the step of using said centralized management system includes the step of using said centralized management system to create a user account validity definition, and to identify in said definition which ones of the users are valid on which ones of the computer systems.

3. A method according to claim 1, comprising the further steps of:
providing each of the computer systems of the cluster with a user authentication module; and
when one of the users requests authentication on one of the computer systems, using said user authentication module of said one of the computer systems to determine whether said one of the users is valid on said one of the computer systems.

4. A method according to claim 3, wherein:
the step of using said centralized management system to maintain a record includes the step of maintaining a list on the centralized management system identifying which of the users have access to which of the computer systems; and
the step of using the authentication module includes the step of using the authentication module to ask the centralized management system whether said one of the users is valid on said one of the computer systems.

5. A method according to claim 3, comprising the further step of:
providing each of the computer systems with a cache of user account values; and
wherein the step of using the authentication module includes the step of using the authentication module of said one of the computer systems to access the cache of user account values of said one of the computer systems to determine if said one of the users is valid on said one of the computer systems.

6. A method according to claim 1, wherein the using step includes the steps of:
identifying groups of nodes; and
for each of at least some of the users, identifying which ones of the computer systems that said user is valid on by identifying one of said group of nodes.

7. A system for defining user account validity in a cluster of computer systems, the system comprising
a centralized manager for said cluster; and
said centralized manager including means to maintain a record indicating, for each user of the cluster, whether the user is valid on each of the computer systems in the cluster.

8. A system according to claim 7, wherein the means to maintain a record includes means to create a user account validity definition, and to identify in said definition which ones of the users are valid on which ones of the computer systems.

9. A system according to claim 7, further comprising:
a plurality of user authentication modules, each of the computer systems of the cluster being provided with one of the user authentication module; and
wherein, when one of the users requests authentication on one of the computer systems, said one of the computer systems uses the user authentication modules of said one of the computer systems to determine whether said one of the users is valid on said one of the computer systems.

10. A system according to claim 9, wherein:
the means to maintain a record includes means to maintain a list on the centralized manager identifying which of the users have access to which of the computer systems; and
the authentication module of each one of the computer systems includes means to ask the centralized manager whether one of the users is valid on said one of the computer systems.

11. A system according to claim 9, wherein:
each of the computer systems includes a cache of user account values; and
when one of the users requests authentication on one of the computer systems, said one of the computer systems uses the user authentication module of said one of the computer systems to access the cache of user account values of said one of the computer systems to determine if said one of the users is valid on said one of the computer systems.

12. A system according to claim 7, wherein the centralized manager includes:
means for identifying groups of nodes; and
means for identifying, for each of at least some of the users, which ones of the computer systems that said user is valid on by identifying one of said groups of nodes.

13. A program storage device readable by machine, tangibly embodying a program of instructions executable by the machine to perform method steps for defining user account validity in a cluster of computer systems, the method comprising the steps of:
accessing a centralized management system for said cluster; and
using said centralized management system to maintain a record indicating, for each user of the cluster, whether the user is valid on each of the computer systems in the cluster.

14. A program storage device according to claim 13, wherein the step of using said centralized management system includes the step of using said centralized management system to create a user account validity definition, and to identify in said definition which ones of the users are valid on which ones of the computer systems.

15. A program storage device according to claim 13, wherein said method steps comprise the further steps of:
providing each of the computer systems of the cluster with a user authentication module; and
when one of the users requests authentication on one of the computer systems, using said user authentication module of said one of the computer systems to determine whether said one of the users is valid on said one of the computer systems.

16. A program storage device according to claim 15, wherein:
the step of using said centralized management system to maintain a record includes the step of maintaining a list on the centralized management system identifying which of the users have access to which of the computer systems; and
the step of using the authentication module includes the step of using the authentication module to ask the centralized management system whether said one of the users is valid on said one of the computer systems.

17. A program storage device according to claim 15, wherein said method steps comprise the further step of:
providing each of the computer systems with a cache of user account values; and
wherein the step of using the authentication module includes the step of using the authentication module of said one of the computer systems to access the cache of user account values of said one of the computer systems to determine if said one of the users is valid on said one of the computer systems.

18. A program storage device according to claim 13, wherein the using step includes the steps of:
identifying groups of nodes; and
for each of at least some of the users, identifying which ones of the computer systems that said user is valid on by identifying one of said group of nodes.
